(19) United States
(12) Patent Application Publication
(10) Pub. No.: US 2007/0094127 A1
(43) Pub. Date: Apr. 26, 2007

(54) Mortgage management system and method

(76) Inventor: Roman Izyayev, Staten Island, NY (US)

Correspondence Address: OSTROLENK FABER GERB & SOFFEN, 1180 AVENUE OF THE AMERICAS, NEW YORK, NY, 100368403, US

(21) Appl. No.: 11/496,783

(22) Filed: Jul. 27, 2006

Related U.S. Application Data
(63) Continuation-in-part of application No. 11/257,172, filed on Oct. 24, 2005.

(51) Int. Cl. G06Q 40/00

(52) U.S. Cl. 705/38

(57) ABSTRACT

A system and method for reducing mortgage payments and operable in conjunction with an insurance policy. The system comprises a first module that contains information regarding terms of a mortgage. The terms include a principal amount of a mortgage, and an interest rate for the mortgage. Further, a second module contains information regarding terms of an insurance policy that is in existence during the life of the mortgage. The terms of the insurance policy preferably include the total amount of proceeds of the insurance policy, the premium amount to be paid for the insurance policy, and the beneficiary of the life insurance policy. Further the invention includes a tracking system that tracks interest payments made on the interest of the mortgage and further tracks premium payments made on the premium amount on the insurance policy. The proceeds from the insurance policy are reserved to pay the principal on the mortgage.

### CROSS REFERENCE TO RELATED APPLICATION

This is a continuation in part of application Ser. No. 11/257,172, filed Oct. 24, 2005 in the name of Roman IZYAYEV and entitled MORTGAGE MANAGEMENT SYSTEM AND METHOD, the entire contents of which are incorporated herein by reference.

### FIELD OF THE INVENTION

The present invention relates generally to mortgages, and more particularly, to applying proceeds from a life insurance policy to cover the principal amount of a mortgage.

### BACKGROUND OF THE INVENTION

The dream of owning one's own house remains paramount in the minds of many people. Unfortunately, the realities associated with costs associated with a house cause many to never realize that dream.

In particular, the ability for one to obtain a mortgage in order to purchase a house often depends on that person's financial habits, which are tracked by creditors. Lenders simply won't extend credit after determining that the level of risk associated with a borrower is too high. Typically, credit-reporting agencies receive information from various creditors regarding a person's ability and history of paying bills and satisfying various credit allegations. The information received by the credit reporting agencies is then provided to lenders. Lenders use the information to predict the likelihood that a borrower will satisfy payment obligations associated with a mortgage. Thus, a poor credit report can significantly jeopardize a person's ability to obtain a mortgage and purchase a house.

In addition to credit ratings, other impediments prevent people from obtaining mortgages and purchasing a house. For example, many lenders require a significant outlay of capital (i.e., a down payment) that can amount to tens of thousands of dollars. Depending on a purchaser's credit reputation, a down payment can range between 10-30%, or higher, of a house's price. Often, buyers are also required to pay closing costs up front, which can amount to 3-6% of the loan. Thus, requirements for an initial outlay of capital act as an impediment to obtaining a mortgage.

Another impediment to obtaining a mortgage and purchasing a house regards a buyer's capacity with respect to the buyer's income, debt and cash reserves. If a buyer has a significant amount of debt, low cash reserves and low or even no income, even if only temporary, lenders may be unwilling to extend a loan. Thus, a buyer's capacity also can impede the ability to obtain a mortgage and purchase a house.

Another variable considered by lenders is a borrower's collateral, such as real estate, automobiles and capital investments, such as securities, bonds or the like. A borrower with little to no collateral may be unable to obtain a mortgage. Thus, people seeking to obtain a mortgage may be denied for various reasons. Insufficient income, insufficient funds for a down payment, insufficient collateral, poor credit history or the like are often cited reasons for denying a mortgage applicant a loan.

Even for the financially secure, the purchase of a home represents the diversion of equity, i.e., funds on hand, toward a substantial downpayment on a home and, over time, to payment of principal on a home in the form of a portion of each monthly mortgage payment. The tying up of those funds in payments of principal on a home, prevents those very same funds from being invested in other types of investments which may yield higher returns.

Many kinds of mortgages are available for prospective borrowers. For example, conventional loans, government loans, fixed rate loans, adjustable rate loans and combinations thereof impose varying types and degrees of conditions on borrowers with respect to required down payments, years to repay, amounts of interest to pay or the like. In a fixed rate mortgage, the interest rate and mortgage monthly payments remain fixed for the period of the loan. For example, fixed rate mortgages are available for thirty, twenty-five, twenty, fifteen and ten year spans. In general, the shorter period of time for a loan, the lower the interest rate the borrower has to pay. The advantage to an extended loan, such as a thirty-year loan with a relatively high interest rate is that monthly payments are typically lower than they would be on a shorter-term loan. Thus, a borrower who can afford a higher monthly payment can save tens of thousands of dollars by obtaining a fifteen-year fixed rate mortgage as opposed to a thirty-year fixed rate mortgage. Other types of loans are available such as balloon loans (requiring fixed monthly payments with a lump sum payment at the end of the mortgage term), adjustable rate mortgages (a mortgage having an interest rate and monthly payments that fluctuate over the life of the loan) and hybrid loans (combination of fixed and adjustable rate mortgage loans) provide varying options for borrowers, depending upon a borrower's financial circumstances.

Notwithstanding the various types of mortgage loans available for consumers, a prospective borrower with a poor credit history, low income and little or no collateral is likely to be denied a mortgage, or else forced to pay a high down payment and accept poor borrowing terms.

### SUMMARY OF THE INVENTION

The present invention recognizes that alternative financing arrangements are desired by prospective borrowers in order to obtain a mortgage and, accordingly, purchase a house. In one form thereof, the invention combines and inextricably intertwines whole life insurance with a mortgage, i.e., the purchase of a house. The present invention ensures that payments of the principal amount on a mortgage are paid by proceeds from a life insurance policy. The mortgagee (borrower) is responsible for paying the interest on the mortgage and life insurance premium

The present invention results in lower monthly payments for the borrower because interest-only payments are paid by the borrower. The borrower (or other third party) is further responsible for maintaining an insurance policy, such as a life insurance policy, of which the proceeds are applied exclusively to the principal of the mortgage. In a preferred embodiment, payments toward the principal amount of the mortgage can be made by the borrower, which results in a reduction in the proceeds of the insurance policy and, accordingly, results in a lower insurance premium and lower interest payments.

In accordance with a preferred embodiment, borrowers are responsible for interest-only payments on a mortgage, and are further responsible for premium payments associated with a life insurance policy. The proceeds of the life insurance policy are reserved for the principal amount of the mortgage. In this way, borrowers realize the benefit of foregoing a need to make payments towards the principal of a mortgage, and further have the benefit of insurance that a mortgage will be satisfied in case of an unfortunate event, such as an untimely death.

Further, lenders are assured that loans they grant will be paid back because the principal amount is guaranteed by the proceeds of a life insurance policy. Preferably, a lender (i.e., a mortgagor) is also the insurance provider, as well as owner and the beneficiary of the life insurance policy. In this way, the mortgagor is guaranteed that the principal on the mortgage will be satisfied, and will have use of and control over the policy cash value. Moreover, the mortgagor maintains control by having the right to foreclose on the mortgaged property in case the borrower defaults on either the life insurance premium, the interest payment on the mortgage, or both.

Thus, the present invention includes a system for reducing mortgage payments and is operable in conjunction with an insurance policy. The system comprises a first module that contains information regarding terms of a mortgage. The terms include a principal amount of a mortgage, and an interest rate for the mortgage. Further, a second module contains information regarding terms of an insurance policy that is in existence during the life of the mortgage. The terms of the insurance policy preferably include the total amount of proceeds of the insurance policy, the premium amount to be paid for the insurance policy, and the beneficiary of the life insurance policy. Further the invention includes a tracking system that tracks interest payments made on the interest of the mortgage and further tracks premium payments made on the premium amount on the insurance policy. The proceeds from the insurance policy are reserved to pay the principal on the mortgage.

In one form thereof, the concept of the present invention capitalizes on the advantageous tax treatment of life insurance policies, particularly whole life insurance, which permits accumulation of very advantageous investment returns without paying taxes until the policy is cashed or proceeds on the life insurance policy are paid out. Rather than paying or making monthly payments on mortgages with aftertax dollars to reduce the principal amount, such payments are made into the whole life portion of the intertwined mortgage/insurance construct, where cash value builds up more rapidly and at higher return rates than would otherwise be attainable by an individual.

The accumulated and growing cash value of the policy in effect is paying off the principal amount of the mortgage without the mortgage itself reflecting this constant paying off of that principal.

Preferably, the combined mortgage/insurance product is designed to build a cash value equal to the mortgage amount in thirty years, or to build a sufficient cash base to cover the monthly payments in thirty years in perpetuity.

Other features and advantages of the present invention will become apparent from the following description of the invention which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in a preferred embodiment of the present invention;

FIG. 2 illustrates the functional elements of a user terminal and/or information processor;

FIG. 3 illustrates an embodiment of the present invention comprising a borrower, insurance policy and a mortgage;

FIG. 4 is a block diagram that illustrates an example networked arrangement of parties associated with the present invention;

FIG. 5 illustrates a portion of an example a mortgage application display screen in accordance with an embodiment of the present invention; and

FIG. 6 illustrates a portion of an example life insurance policy application display screen 600 in accordance with a preferred embodiment.

### DETAILED DESCRIPTION OF THE PREFERRED EMBODIMENTS

The present invention enables mortgagees (i.e., borrowers) to obtain a mortgage and to pay only interest on the loan. The principal of the mortgage is preferably paid by revenue originating from an external source, such as a life insurance policy, that is maintained by the borrower and which directs the lender to be the beneficiary. Thus, unlike typical prior art mortgage payments that combine interest and principal payments, the present invention directs that payments of the principal amount of a mortgage to be paid from proceeds of a life insurance policy, following an event that triggers payment of proceeds, such as the death of the policy holder or another event which terminates the mortgage, e.g., its maturity. The mortgagee is responsible for interest-only payments on the mortgage, and is further responsible for maintaining an insurance policy that guarantees payment of the principal amount. The mortgagor is preferably the same party as the insurer, and is further the owner and the beneficiary of the policy. In this way, the mortgagor is able to exercise control in the event that the borrower (i.e., mortgagee) defaults on the loan.

A typical prior art life insurance policy names at least one person to receive the life insurance proceeds (i.e., a beneficiary) upon some event that triggers proceed payments, such as the death of the insured. Payments to the insurance company, for example, by the insured (i.e., premiums) ensures the life insurance policy is in force until some terminating event, such as voluntary termination, lack of premium payments, or death of the insured. Various forms of life insurance are available, such as term life insurance, which does not build up cash value and where the premium normally increases as the insured gets older. Whole life insurance (or “permanent” insurance), in contrast, typically builds up a cash value and has a fixed level of premiums. Both term life insurance and whole life insurance, generally, require premiums to be paid as long as the policy remains in force. Either term life insurance, whole life insurance, or some combination thereof can be used in accordance with the teachings herein. Furthermore, term insurance may be converted to whole life insurance during the life of the insured.

Compared to conventional mortgages, where payment towards principal is included in monthly payments, interest-only payment reduces monthly payments. In accordance with an embodiment, in order to reduce monthly payments even further (than interest-only), a negative amortization mortgage may be used, as known to those skilled in the art. In accordance with this embodiment, the amount by which each monthly payment is reduced is preferably added to the principal amount borrowed for the total balance that has to be paid off. In accordance with the teachings herein, the remaining (total) balance is paid from life insurance proceeds, thereby resulting in an increase in the amount of life insurance purchased by the borrower.

In yet another embodiment, in order to exercise the control that a mortgagor has over a policy, in the States where the law does not permit for a lender to own the life insurance policy on the borrower's life, a trust is preferably established that defines mortgagor as the beneficiary. In accordance with this embodiment, the mortgagor realizes the benefits of the trust in case of a default in payment in the life insurance premiums, the interest payments on the mortgage, or both. To the extent that a principal of the trust has accrued, the body of the trust is preferably the cash value of the life insurance policy. Also in accordance with this embodiment, the mortgagee does not own the cash value of the insurance policy. Instead, the cash value is protected in the trust, and falls under the control of the lender in case of default on payments of premium

Moreover, the life insurance policy may support a disability waiver that can be extended to cover interest payments on the mortgage. For example, the mortgagee may pay an additional amount for the life insurance policy to cover payments the mortgagee is unable to make in case of becoming disabled. Thus, a disability rider clause can be included, optionally at an additional cost, to rider which provides payments to cover one or both of the interest payments on the mortgage and the premium payments on the life insurance policy during a period of disability.

In an alternative embodiment, a life insurance policy may be purchased on the life of a borrower's parent or close-relative, who has a shorter life-expectancy than the borrower. In this embodiment, the likelihood is that the triggering event resulting in payment proceeds on the insurance policy will occur much sooner than if the policy was taken for the borrower (i.e., mortgagee). The benefit of this embodiment is that the principal of the mortgage will likely be paid sooner rather than later. In other words, the life insurance policy is taken for a person who is likely to die sooner than the borrower. The burden of this embodiment is that the monthly premiums are likely to be higher than if the life insurance policy is on the borrower. Typically, and particularly with respect to term insurance, the amount of premium payments increase as the likelihood of the insured party's death becomes more imminent. Thus, premium payments on a life insurance policy on a twenty-five year old are much lower than premium payments on a sixty-five year old.

As noted above, a whole life insurance policy has a guaranteed cash value accumulation. Further, a whole life insurance policy has an annual dividend which, typically, is not guaranteed. In case whole (or permanent) life insurance is purchased, or a combination of whole and term is purchased, then in accordance with the teachings herein, three formulas for calculating monthly payments are envisioned herein. Each of the formulas relates to an annual calculation which is divided by twelve (for the number of months in the year). First, the dividends option may be used to reduce the premium and calculated as: (mortgage amount−guaranteed cash value)*interest rate+annual insurance premium−annual dividends=required payment. Second, the dividends option may be used to increase the policy's cash value and calculated as: (mortgage amount−policy cash value)*interest rate+annual insurance premium=required payment. Third, monthly payments (preferably defined as (((mortgage amount*interest rate)+annual insurance premium amount)/12) may remain unchanged, and the difference between the monthly payments and a required monthly payment (preferably calculated as ((mortgage amount−policy cash value)*interest rate)+annual insurance premium)/12) is used to increase a policy's cash value (known in the art as an “enricher rider”). In this case, the dividends option may be used to increase a policy's cash value until annual dividends are equal or higher than a required monthly payment amount and can be used to make required payments. The formula to calculate enricher rider amount is: ((mortgage amount*interest rate) +annual insurance premium amount)/12)−required monthly payment=enricher rider amount.

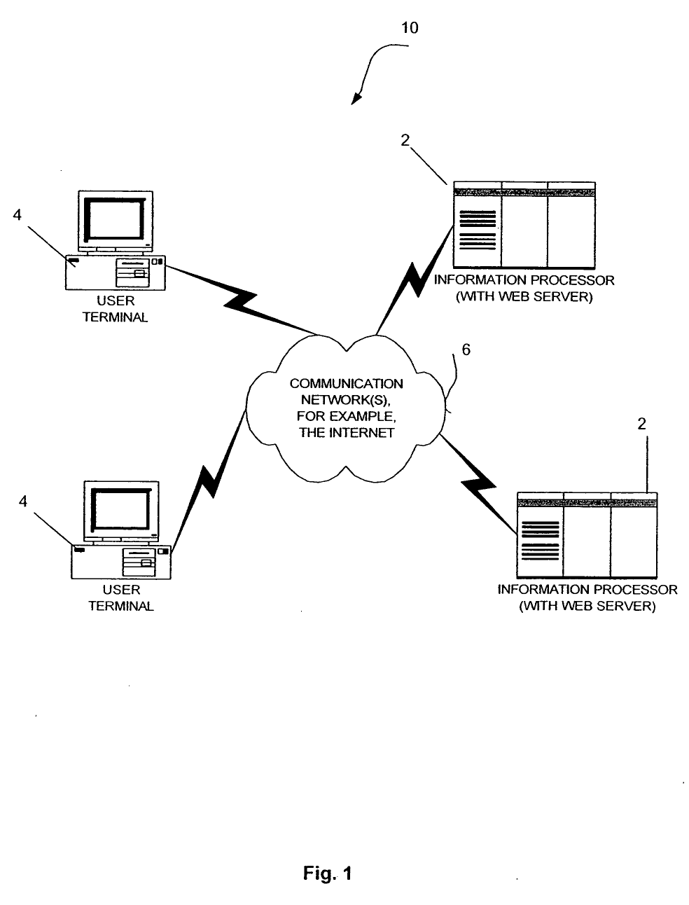

Referring to the drawings, in which like reference numerals refer to like elements, FIG. 1 shows an example hardware arrangement in a preferred embodiment of the present invention and referred to generally as system 10. In the embodiment shown in FIG. 1, system 10 comprises at least one information processor 2 (configured to operate as an internet web server) adapted to access communication network 6 and communicate with user terminals 4. Preferably, user terminals 4 and information processor(s) 2 communicate via the known communications protocol, Transmission Control Protocol/Internet Protocol “TCP/IP.” In this way, content can be transmitted to and from the devices 2 and 4, and commands can be executed to enable the various functions described herein.

As used herein, the term, “module” refers, generally, to one or more discrete components that contribute to the effectiveness of the present invention. Modules can operate or, alternatively, depend upon one or more other modules in order to function.

Information processors 2 and user terminals 4 are any devices that are capable of sending and receiving data across communication network 6, e.g., mainframe computers, mini computers, personal computers, laptop computers, a personal digital assistants (PDA) and internet access devices such as Web TV. In addition, information processors 2 and user terminals 4 are preferably equipped with a web browser, such as MICROSOFT INTERNET EXPLORER, NETSCAPE NAVIGATOR, MOZILLA FIRREFOX or the like. Thus, as envisioned herein, information processor 2 and/or user terminals 4 are devices that can communicate over a network and can be operated anywhere, including, for example, moving vehicles.

The nature of the present invention is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, and a plurality web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on user terminals 4 and information processor 2, for example, DOS, WINDOWS 3.×, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, the present invention preferably supports various suitable multi-media file types, including (but not limited to) JPEG, BMP, GIF, TIFF, MPEG, AVI, SWF, RAW or the like (as known to those skilled in the art).

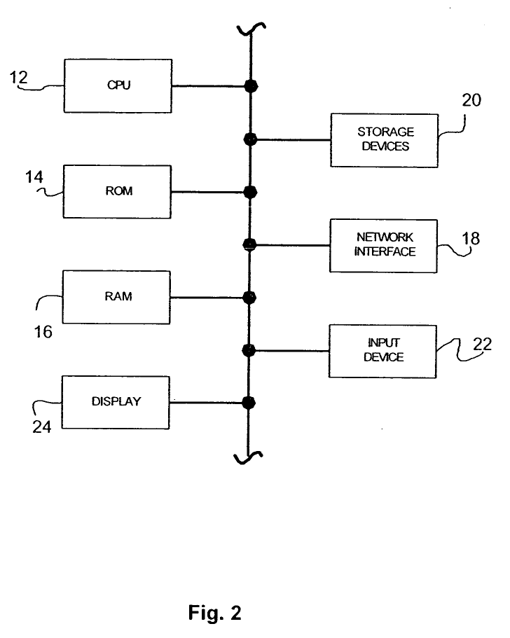

FIG. 2 illustrates the functional elements of user terminal 4 and/or information processor 2 and that include one or more central processing units (CPU) 12 used to execute software code and control the operation of user terminal 4, read-only memory (ROM) 14, random access memory (RAM) 16, one or more network interfaces 18 to transmit and receive data to and from other computing devices across a communication network, storage devices 20 such as a hard disk drive, floppy disk drive, tape drive, CD ROM or DVD for storing program code, databases and application data, one or more input devices 22 such as a keyboard, mouse, track ball, microphone and the like, and a display 24.

The various components of information processor 2 and/or user terminal 4 need not be physically contained within the same chassis or even located in a single location. For example, storage device 20 may be located at a site which is remote from the remaining elements of information processor 2 or user terminal 4, and may even be connected to CPU 12 across communication network 6 via network interface 18. Information processor 2 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on user terminals 4. Information processors 2 are arranged with components, for example, those shown in FIG. 2, suitable for the expected operating environment of information processor 2. The CPU(s) 12, network interface(s) 18 and memory and storage devices are selected to ensure that capacities are arranged to accommodate expected demand.

As well understood by those of ordinary skill in the art, FIG. 2 represents a basic computer construct consisting of hardware and software for executing the various steps and for delivering the results described herein for the system of the present invention. That system, including its hardware and software components, is designed to carry out the various calculations needed to derive the exact payments that are payable both relative to the mortgage and to the life insurance policy or policies.

One of the software modules of the present invention may include a tax benefits calculator designed to derive or calculate the highest payment permissible on the insurance policy which will maximize the favorable tax treatment under the then-current tax laws of the United States. For example, the software will calculate for a particular mortgage balance and insured the amounts required to be paid to permit sufficient monthly contributions or payments on the life insurance policy that will allow building up the desired cash amounts at the conclusion of a predefined or selectable time period.

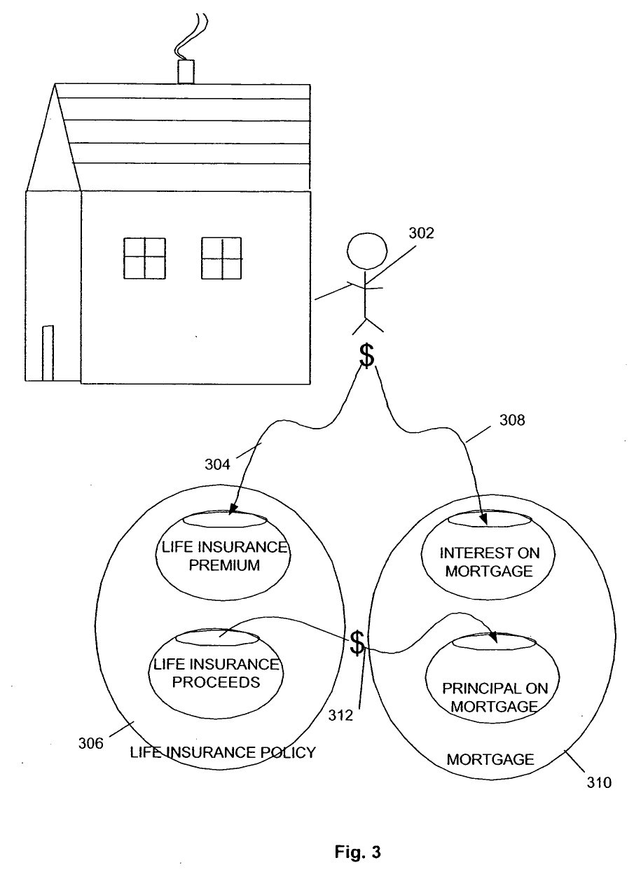

FIG. 3 illustrates an embodiment of the present invention. As shown in FIG. 3, borrower 302 remits two kinds of financial payments: one payment 304 for paying a premium on life insurance policy 306, and one payment 308 for paying the interest on mortgage 310. Although the embodiment in FIG. 3 shows a single person making both payments 304 and 308, the invention is not so limited. It is envisioned herein that a plurality of parties may make payments 304 and 308, without departing from the teachings herein. For example, prior art life insurance policies typically designate beneficiaries who do not contribute financially to the costs associated with the policy (i.e., make premium payments). Furthermore, in the prior art, a third party may pay for a house owned by another party that is named on the property deed. Thus, it is envisioned herein that one or more parties may contribute payments 304 and 308, at least to the extent permitted by law.

Continuing with reference to FIG. 3, payments 312 are preferably made from proceeds of life insurance policy 306 which are applied to the principal of mortgage 310. Unlike prior art arrangements wherein a beneficiary realizes the proceeds of a life insurance policy and, thereafter, can make mortgage-related payments, the present invention preferably regards life insurance policy proceeds that are reserved exclusively for the principal of a mortgage. One skilled in the art will recognize that a borrower may make payments that are applied to the principal of a mortgage. Any payments applied to the principal results in a reduction in interest-only payments and further a reduction in the premium of the life insurance policy because the principal amount of the mortgage is reduced.

Preferably, information processor 2 tracks payments that are made by borrower 302 (or other party) that are applied to the premium of the life insurance policy, to the interest only payments on the mortgage, and/or to the principal of the mortgage. By tracking these payments, information processor 2 preferably determines appropriate adjustments to the life insurance policy, the premiums of the life insurance policy and to the interest only payments on the mortgage. Further, information processor 2 preferably operates to guarantee that the life insurance policy is sufficient cover the outstanding principal on the mortgage.

In accordance with the teachings herein, the mortgagor (i.e., lender) and the insurer may be the same party. For example, a person takes out a life insurance policy with a company, and further takes out a mortgage with the same company. The mortgagor (i.e., the company) may use the proceeds that it pays from the life insurance policy to cover the principal amount of the mortgage. Moreover, businesses that were at one time exclusively involved in either the insurance industry or the lending industry may evolve into some sort of hybrid in order to be availed of the methods and/or systems defined herein. In this way, mortgagors can exercise control in case the borrower defaults on either the monthly insurance premiums, the monthly interest payments or both, by foreclosing on the property. Moreover, lenders are guaranteed payment of the principal amount of a loan by being beneficiaries of life insurance policies.

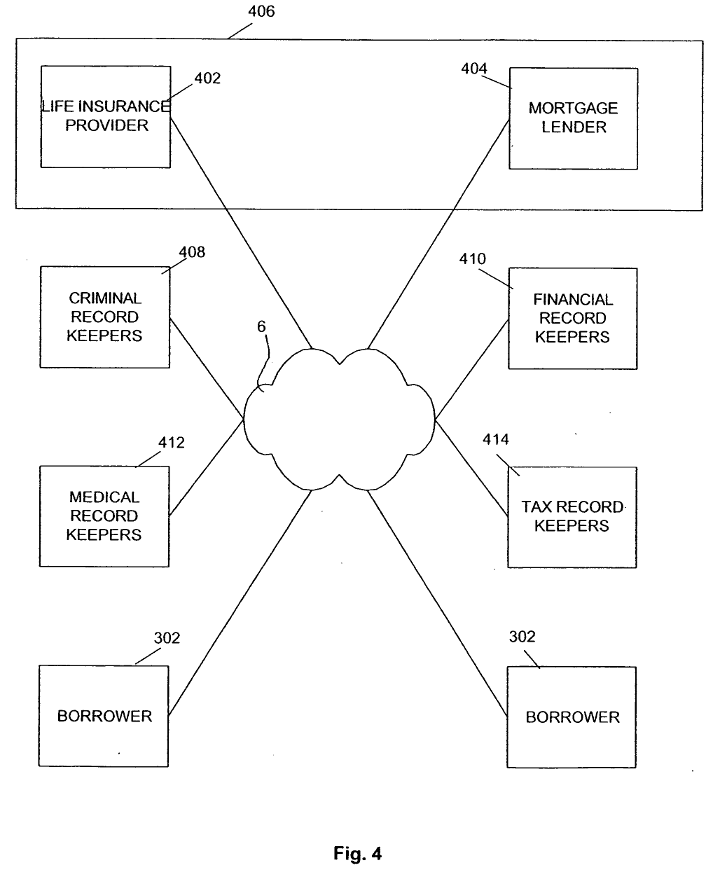

FIG. 4 is a block diagram that illustrates an example networked arrangement of parties associated with the present invention. As noted with reference to FIGS. 1 and 2, the present invention is operable, preferably, over one or more communication networks, such as the internet. The present invention enables various parties to communicate information to each other that is useful or necessary to execute the teachings herein. For example, issuers of life insurance policies and issuers of mortgages require various kinds of information in order to make an informed decision whether to insure someone or grant a mortgage to someone. One skilled in the art will recognize that the internet enables the convenient and rapid exchange of information, thereby enabling parties to decide whether to grant someone a life insurance policy and/or a mortgage.

Continuing with reference to FIG. 4, life insurance provider 402 and mortgage lender 404 are shown surrounded by a dotted line. The dotted line symbolizes that the life insurance provider 402 and mortgage lender 404 may be the same company 406, or, alternatively, different companies. Other information providers represented in FIG. 4 include criminal records keepers 408, financial record keepers 410, medical record keepers 412, generally and tax record keepers 414. The term “keepers” is merely illustrative, and represent that these parties have access to information, and can provide information to provider 402 and lender 404. Further, one skilled in the art will recognize that various other parties are capable of providing information to life insurance provider 402 and/or mortgage lender 404, and are envisioned herein to be included among the parties listed in FIG. 4. In accordance with the teachings herein, a life insurance provider 402 and/or mortgage lender 404 receives information substantially automatically from various parties acting as sources of information regarding an insurance policy and/or mortgage applicant.

For example, a prospective mortgagee who desires to avail himself of the benefits of the present invention applies for a life insurance policy and a mortgage. The prospective mortgagee logs on to a web site provided by information processor 2 and completes a data entry form to submit an application for the life insurance policy. The applicant intentionally omits important information regarding his health. The life insurance provider 402 (via information processor 2) uses the information received from the applicant to request additional information about the applicant from various parties, such as represented in the block diagram shown in FIG. 4. A medical records holder of the applicant's health records (e.g., medical records keeper 412) transmits information to provider 402 that identifies the applicant's pre-existing condition. Insurance provider 402 uses the information to avoid insuring someone who dishonestly omits information on his application. This example illustrates how information can be transmitted between parties (such as shown in FIG. 4) in order to enable accurate and timely decisions regarding insuring someone and/or granting someone a mortgage. In another example, a mortgagor receives information from a financial record keeper 410 that indicates a prospective mortgagee is a high-risk applicant. Thus, the present invention enables information to be provided rapidly, preferably over the internet, from a plurality of parties, thereby enabling key players to make informed decisions. Further, the present invention takes advantage of current and known technology for an efficient implementation.

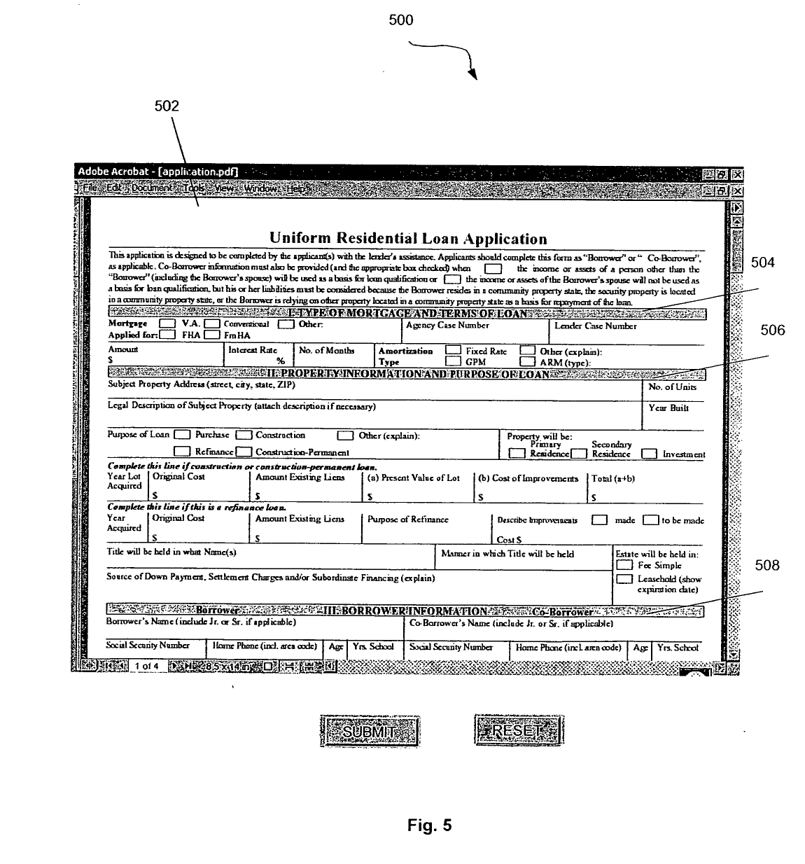

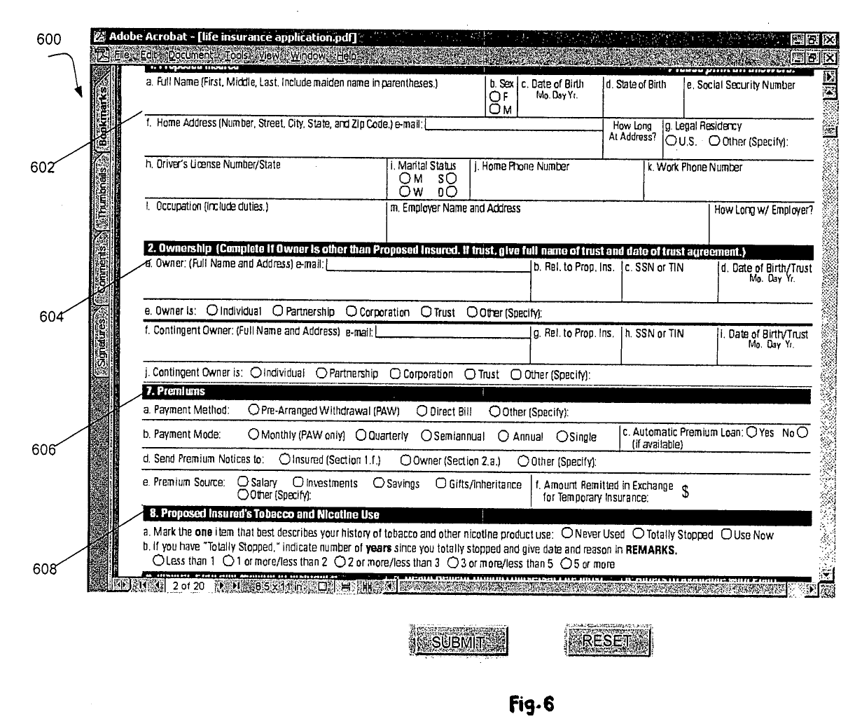

FIGS. 5 and 6 illustrate an embodiment of the present invention wherein prospective borrowers use the internet and the “World Wide Web” to apply for mortgages and/or life insurance policies. Preferably, secure internet web sites are provided by the present invention that enable prospective borrowers to submit information to an information processor in order to avail themselves of the features described herein. For example, information processor 2 functioning in part as an internet web server provides a prospective borrower or other user with secured access (e.g., via the secured sockets layer protocol (“SSL”), encryption, and/or other security-related techniques) to one or more web sites served by information processor 2. The user preferably registers with information processor 2 by submitting information and thereafter provides a user name and password to gain secured access to web sites provided by information processor 2.

FIG. 5 illustrates a portion of an example a mortgage application display screen 500 that preferably includes a data entry form 502 that is provided on the internet and accessible to a user via a standard web browsing software to apply for a mortgage. Data entry form 502 includes graphical screen controls, such as text boxes, check boxes, radio buttons, buttons or the like that enable a mortgage applicant to submit information in an application which is used by a mortgagor to grant or deny a mortgage. With particular reference to the example shown in FIG. 5, mortgage type section 504 includes graphical screen controls that enable an applicant submit information regarding the type of mortgage the applicant desires (e.g., V.A. Federal Housing Authority, Conventional, or the like), the amount of the mortgage, the preferred interest rate, the number of months to pay back the mortgage, the interest type for the mortgage (e.g., fixed or variable), or the like.

Continuing with reference to FIG. 5, the data entry form 502 includes property information section 506 that includes controls enabling a user to submit information regarding the property and/or purpose of the mortgage. For example, the applicant submits information regarding the physical information about the property (e.g., address, and legal description), whether the loan is for a purchase, refinance, construction, or the like, whether the property will be a primary residence, secondary residence, investment or the like, and the name of the party holding the title, source of down payment or the like. In borrower section 508 of data entry form 502, the prospective borrower (and co-borrower, if applicable) submits personal information (e.g., name, address, telephone number, social security number, etc.). Data entry from 502 preferably includes various other sections (not shown) that an applicant uses to submit information regarding the mortgage. For example, sections directed to the borrower's 302 present and past employment, the borrower's 302 assets and liabilities, acknowledgements, etc., as typically provided in mortgage applications, are preferably provided and used by the applicant to submit additional information required by the mortgagor to evaluate the loan and the applicant in order to determine whether to grant the mortgage.

After the applicant has completed the application, he preferably submits the application, for example, by selecting a button or other control. The contents of the application are preferably transmitted to the mortgagor (or authorized agent thereof). The mortgagor preferably verifies the applicant's submitted information using known processes, such as by communicating with various parties, such as depicted in FIG. 4, including a credit rating company, a bank or the like.

In addition to applying for a mortgage (FIG. 5), a user of the present invention logs into information processor 2 to access an on-line application for a life insurance policy, of which of the proceeds are reserved exclusively for the principal of a mortgage.

FIG. 6 illustrates a portion of an example life insurance policy application display screen 600 that includes data entry form 602 for submitting an application for a life insurance policy in accordance with a preferred embodiment. Data entry form 602 includes demographics section 604, in which a user submits personal information (e.g., name, address, gender, date of birth, social security number, driver's license number etc.). Ownership section 606 is used to identify whether the owner of the policy is different from the proposed insured party. Premiums section 608 includes data entry controls to be used by the applicant to submit information directing how premium payments are to be made, the frequency of premium payments or the like. Tobacco and nicotine section 610 is preferably provided for the applicant to inform the insurer of present and past tobacco use.

Data entry from 602 preferably includes various other sections (not shown) that an applicant uses to submit information regarding the insurance policy. For example, sections directed to the applicant's medical history, existing insurance policies, authorization to collect and disclose information, and the like are preferably provided to the applicant.

After the applicant has completed the application, he preferably submits the application, for example, by selecting a button or other control. The contents of the application are preferably transmitted to the insurance provider 402 (or authorized agent thereof). The insurance provider 402 preferably verifies the applicant's submitted information using known processes, such as by communicating with various parties, such as depicted in FIG. 4, including a credit rating company, a bank or the like.

Once the mortgage application and/or the insurance policy are approved, then, in accordance with a preferred embodiment, interest payments on the mortgage and premium payments on the life insurance policy are paid by borrower 302 (or other party), and the principal of the mortgage is to be paid by the proceeds from the insurance policy. The proceeds are preferably paid after some triggering event, such as death of the insured. Moreover and as described above, payments can also be applied to the principal of a mortgage (for example, by the borrower), thereby lowering interest payments and also lowering the terms of the life insurance policy and, accordingly, lowering the premium on the life insurance policy. Notwithstanding a life insurance policy fluctuating in response to payments applied to the principal of a mortgage, the proceeds of the insurance policy will be sufficient to cover the principal balance on the mortgage.

Thus the present invention provides a new and useful way for borrowing and lending capital that is beneficial to both lenders and borrowers. Lenders (acting as insurers and mortgagors) have an increased opportunity to sell mortgages in a cost effective way, and will increase the number of sales of life insurance policies. Further, the invention provides protection to a lender against default, typical in the prior art, due to premature death of a borrower. Lenders also maintain a higher degree of control over their loans by maintaining a right to foreclose on property in case a borrower defaults on life insurance premium payments and/or mortgage interest payments.

Thus, paying interest-only on a mortgage makes it easier to buy a dream house, however, the idea that principal will have to be paid off is a burden and a psychological barrier to most borrowers. The present invention alleviates this burden and barrier.

Borrowers benefit by the present invention because mortgages are more affordable than in the prior art. Moreover, families of borrowers are protected against losing a house in the event of a borrower's death and/or disability. Moreover, in case of hardship, the cash value of a life insurance policy can be used to make monthly payments. Moreover, the invention provides greater flexibility for borrowers who can purchase from a variety of life insurance policy types, and maintain within a suitable monthly budget.

Other features of the invention are envisioned herein. Preferably, the present invention assures that a minimum amount of capital, for example, six months worth of insurance premium payments, are held, for example in an escrow account, in order to guarantee that an insurance policy will not lapse for lack of payment of premiums. In this way, a policy holder may default on paying premiums for a certain amount of time, and the lender is protected because the insurance policy will remain in force.

Also, although the examples provided herein regard a single life insurance policy, of which the proceeds are applied to the principal of a single mortgage, the invention is not so limited. For example, it is envisioned that proceeds from a single life insurance policy may be applied to a plurality of mortgages.

Thus, the present invention provides a useful way to enable a borrower 302 to obtain and satisfy mortgages for the purchase of a house. In particular the present invention provides benefits to consumers because monthly payments for the borrower 302 will be lower than in the prior art. By spreading the costs associated with only interest on a mortgage over time, monthly costs are much lower than those that factor in costs associated with the principal. Even when combined with premium payments associated with a life insurance policy, consumers will have lower monthly payments, thereby freeing capital. The combination of mortgage interest payments and insurance premiums compared with a conventional mortgage that includes both interest and principal payments can result in hundreds or even thousands of dollar savings per month.

Further, by making it easier for borrowers 302 to get mortgages, and by increasing the likelihood that mortgages will be paid in full, the invention is attractive for lenders. The practical effect is that the numbers of mortgages being granted will increase and the likelihood that those mortgages that are granted under the terms described herein will be satisfied similarly increases.

Also, although the present invention is described largely in terms of a mortgage for a residential house, the invention is not so limited. It is envisioned herein that the present invention is applicable for commercial real estate, as well as residential real estate. Further, as noted above, mortgages may be granted for various reasons, including for a primary residence, a secondary residence, an investment transaction or the like. Furthermore, although many of the examples herein regard life insurance as a source of revenue to be applied to the principal of a mortgage, the invention is not so limited. It is envisioned herein that the proceeds from virtually any form of insurance can be used to cover costs associated with the principal of a mortgage. For example, proceeds related to health insurance, property insurance, etc., can be reserved exclusively to applied to paying the principal on a mortgage.

The system and software construct described above may be specifically designed to build cash value within a whole life insurance policy, approximately equal to the principal owed on a mortgage in a set time period, for example, thirty years. Alternatively, the insurance policy can be set up to build up sufficient cash to cover the total monthly payments on interest after a set number of years; for example, thirty years.

The software system may additionally include a software module designed to constantly evaluate the rate of return in the whole life insurance policy and to increase or decrease the payments on the insurance policy to achieve the foregoing results. Such a program may include analysis software which takes into account the borrower's age and life expectancy and terminate upon the borrower's death.

The system of the present invention may allow the life insurance component thereof to either close when the underlying property, i.e., the house, is sold, or to be transferred to a new property. In other words, the mortgage amount and the intertwined insurance policy may be transferred from property to property. The ends of the present invention can be reached by providing a single type of insurance or, perhaps, permanent insurance, such as whole life, UL or VUL, term insurance or combinations of such insurance products. An additional feature of the present invention is to incorporate in the system a borrowing facility which enables a borrower to borrow against the cash value of the insurance policy, subject to underwriting. This can extend the thirty year guarantee to cover monthly payments.

In accordance with another optional feature of the invention, to enhance the policy so as to increase cash and dividend accumulation, a portion of the interest payments received from the borrower on the mortgage may be invested in the insurance policy (for example, 0.125% or 0.25%). Additionally, in the situation where there is a down payment on the purchase of the home, entire down payment or a portion thereof may be designated for being invested in an insurance policy. For example, 1% of the mortgage.

Thus, although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A system for reducing mortgage payments on a mortgage and operable in conjunction with an insurance policy, which is intertwined with the mortgage, the system comprising:
a first module that contains information regarding terms of a mortgage, wherein the terms include a principal amount of a mortgage, and an interest rate for the mortgage;
a second module that contains information regarding terms of a life insurance policy that is intertwined with the mortgage, wherein the terms of the insurance policy information about proceeds of the insurance policy, the premium amount to be paid for the insurance policy, and the beneficiary of the life insurance policy; and
a tracking module that tracks interest payments made on the mortgage and associates therewith potential proceeds and/or value of the insurance policy, wherein the potential proceeds and/or value of the insurance policy are reserved to pay the principal on the mortgage.

2. The system of claim 1, wherein the life insurance policy comprises a whole life insurance policy that builds up a cash value which is earmarked in the system for eventually paying off the balance of the mortgage.

3. The system of claim 2, wherein the whole life insurance policy is structured and periodically adjusted by the system to accumulate a cash value which is approximately equal to the mortgage balance at the end of a set time period.

4. The system of claim 1, wherein the first module adjusts the premium amount to be paid for the insurance policy in case interest-only payments do not amount to a total amount owed for interest on the mortgage.

5. The system of claim 1, further comprising a third module that adjusts the premium amount to be paid for the insurance policy when the tracking module registers a payment applied to the principal amount of the mortgage.

6. The system of claim 1, wherein the second module contains information representing a trust, wherein the trust's corpus comprises a cash value of the life insurance policy, the trust's beneficiary is the mortgagor, and the terms of the trust include payment to the beneficiary in case of default on payments of the premium of insurance policy, default on interest payments of the mortgage, or both.

7. The system of claim 1, wherein the insurance policy is a life insurance policy.

8. The system of claim 7, wherein the life insurance policy is for term life insurance, whole life insurance, or combination of one or more of term, whole, UL, and VUL insurance.

9. The system of claim 7, wherein calculated monthly payments can be reduced by applying a formula for a required monthly payment, wherein the calculated monthly payment equals ((mortgage amount*interest rate)+annual insurance premium amount)/12, and wherein the required monthly payment equals:
((mortgage amount−guaranteed cash value of life insurance policy)*interest rate+(annual insurance premium−annual dividends))/12.

10. The system of claim 7, wherein the cash value of the insurance policy can be increased by applying a formula for a required monthly payment, wherein the required monthly payment equals:
(((mortgage amount−policy cash value)*interest rate)+annual insurance premium)/12.

11. The system of claim 10, wherein a cash value of the policy increases by an enricher amount by applying a formula for the enricher amount, wherein the enricher amount equals:
((mortgage amount*interest rate)+annual insurance premium)/12−the required monthly payment.

12. The system of claim 1, further comprising a third module that contains information regarding an escrow account, wherein the escrow account contains a minimum amount of capital to be applied towards the premium amount of the insurance policy.

13. The system of claim 1, further comprising a communication network, an information processor and a workstation, wherein the information processor provides a data entry form for a user of the workstation over the communication network and the data entry form enables the user to apply for the insurance policy or the mortgage.

14. The system of claim 1, wherein the information processor receives information from at least one of party with access to criminal records, financial records, a medical records, tax records, wherein the information enables the information processor to grant the mortgage, the insurance policy or both.

15. The system of claim 7, wherein the mortgagor and the insurer are the same party, as well as owner and the beneficiary of the life insurance policy.

16. The system of claim 1, wherein the system includes a tax optimizing module designed to calculate the largest amount of payments on the insurance policy which can enjoy favorable tax treatment, based on the mortgage balance amount and personal information about an insured.

17. A system for satisfying terms associated with a real estate mortgage, the system comprising:
an insurance policy, wherein the insurance policy includes a condition that, when realized, results in a payment of proceeds; and
a real estate mortgage, wherein the mortgage includes terms for payment of interest and for payment of principal,
wherein the insurance policy dictates that, upon realization of the condition, at least a portion of the proceeds of the insurance policy is reserved exclusively to fund at least a portion of the principal of the mortgage.

18. A method for reducing mortgage payments and operable in conjunction with an insurance policy, the system comprising:
determining terms of a mortgage, wherein the terms include a principal amount of a mortgage, and an interest rate for the mortgage;
determining terms of an insurance policy that is in existence during the life of the mortgage, wherein the terms of the insurance policy include the total amount of proceeds of the insurance policy, the premium amount to be paid for the insurance policy, and the beneficiary of the life insurance policy; and
tracking interest payments made on the interest of the mortgage and further tracks premium payments made on the premium amount on the insurance policy, wherein the proceeds and/or value from the insurance policy are reserved to pay the principal on the mortgage.
